(19) United States
(12) Patent Application Publication
(10) Pub. No.: US 2018/0265222 A1
(43) Pub. Date: Sep. 20, 2018

(54) TRANSPORT SYSTEM USING UNMANNED AERIAL VEHICLE

(71) Applicant: Kunio TAKAGI, Tokyo (JP)

(72) Inventor: Noriko TAKAGI, Tokyo (JP)

(73) Assignee: Kunio TAKAGI, Tokyo (JP)

(21) Appl. No.: 15/781,498

(22) PCT Filed: Dec. 6, 2016
(86) PCT No.: PCT/JP2016/086184

§ 371 Date: Jun. 5, 2018

(30) Foreign Application Priority Data
Dec. 7, 2015 (JP) 2015-238645

(51) Int. Cl. B64F 1/32; B64C 13/18; B64C 13/20; B64C 27/08; B64C 39/02; B64D 47/08; B65D 25/02; B65G 61/00; G05D 1/10

(52) U.S. Cl. CPC B64F 1/32; B64C 13/18; B64C 13/20; B64C 27/08; B64C 39/02; B64D 47/08; B64C 2201/141; B65G 61/00; G05D 1/102; B64C 2201/024; B64C 2201/042; B64C 2201/066; B64C 2201/128; B65D 25/02

(57) ABSTRACT

A transport system using an unmanned aerial vehicle that overcomes restrictions on distance, time, and the like, thereby expanding a deliverable range for improved convenience. A transport system using an unmanned aerial vehicle that is capable of performing three-dimensional movement using electric power supplied thereto. The unmanned aerial vehicle is mounted with a container for storing a cargo to be transported and is flown by means of relay stations that cover the shipment source with the shipment destination of the cargo. The container is provided with a power storage unit for storing electric power to be supplied to the unmanned aerial vehicle, and the power storage unit of the container is charged at the relay station when the container is not being moved.

### FIELD OF THE INVENTION

This invention relates to a transport system using unmanned aerial vehicles three-dimensionally movable upon receiving electric power supply.

### BACKGROUND OF THE INVENTION

Various technologies are considered in utilizing unmanned vehicles, or namely unmanned aerial vehicles three-dimensionally flying space by autopilot or remote control without boarding any human, such as drones. Logistics can be exemplified as one of utilizing methods using such an unmanned aerial vehicle. Currently, such unmanned aerial vehicles are tested and researched for their application as a delivery machine of the next generation, and commercial use in the logistics field has been developed.

Those unmanned aerial vehicles are, however, built with batteries, and assembled to rotate four or more motors and rotors coupled to the motors according to electric power from those batteries. Flying distance is generally in a range from around fifty or sixty meters to around two or three kilometers according to restriction from the batteries; flying time is no more than a period from several minutes to thirty or forty minutes; a deliverable range tends to be narrower in comparison with a situation using trucks as logistics. If the unmanned aerial vehicle is formed with a larger heavier battery to extend the flying distance or to carry a heavy package, the unmanned aerial vehicle may consume unnecessary electric power because the unmanned aerial vehicle carries the heavy battery even during short distance flights or during carriage of light weight packages.

It is an object of the invention, in consideration to the above technical problems, to provide a transport system using unmanned aerial vehicles to break through the restrictions from distance, time, weight, etc. in widening the deliverable range to enhance usability thereof.

### SUMMARY OF THE INVENTION

To solve the above technical problems, one of the aspects of this invention is to provide a transport system using unmanned aerial vehicles three-dimensionally movable upon receiving electric power supply, the transport system including the unmanned aerial vehicles flying from a shipping source to a delivery destination via a relay base in attaching a container thereto for containing a package to be transported, the container being formed with a battery section for charging electric power supplied to the unmanned aerial vehicles, wherein the battery section formed at the container is charged at the relay base during a non-moving period.

According to an aspect of the transport system using unmanned aerial vehicles of the invention, the unmanned aerial vehicle can transmit current position information of the unmanned aerial vehicle to a control apparatus, and the control apparatus can transmit the position information of the relay base, based on the received current position information, to the unmanned aerial vehicle. The relay base is movable while transmitting the position information.

Further according to another aspect of the transport system using unmanned aerial vehicles of the invention, the number of the containers containing the package to be transported is plural, and while each container is managed using specific information, the control apparatus records charge amount information on current charge amounts of the respective containers according to the specific information. The container formed with the battery section may have a charge amount sensor measuring the charge amount of the battery section of the container, and the charge amount information from the charge amount sensor may be sent to the control apparatus.

According to the invention, the unmanned aerial vehicle can receive the electric power supply from the battery section of the container containing the package even during the moving period. The unmanned aerial vehicle therefore can fly in a wider range without restriction from a capacity of the battery of the unmanned aerial vehicle, thereby improving usability of the delivery utilizing the transport system using the unmanned aerial vehicle of the invention.

### BRIEF DESCRIPTION OF THE DRAWINGS

FIG. 1 is an illustration showing a whole system of an embodiment of a transport system using unmanned aerial vehicles according to the invention;

FIG. 2 is a perspective view showing the example of the unmanned aerial vehicle according to the above embodiment when seen from an oblique upper side;

FIG. 3 is a perspective view showing the example of the unmanned aerial vehicle according to the above embodiment when seen from an oblique lower side;

FIG. 4 is a perspective view showing an example of a container according to the above embodiment;

FIG. 5 is a front view showing the example of the container according to the above embodiment;

FIG. 6 is a cross section showing the example of the container according to the above embodiment;

FIG. 7 is a schematic view showing an unmanned aerial vehicle whose arm is coupled to the example of the container according to the embodiment;

FIG. 8 is a schematic bottom view showing the arm coupled to the example of the container with the container according to the embodiment;

FIG. 9 is a perspective view showing an example of a relay base according to the embodiment;

FIG. 10 is a perspective view showing the example of the relay base and an example of the container placed on the relay base according to the embodiment;

FIG. 11 is a schematic view showing an example of a network made of plural relay bases according to the embodiment; and

FIG. 12 is a schematic view showing a data example in a memory table in a control apparatus according to the embodiment.

### DETAILED DESCRIPTION OF EMBODIMENTS

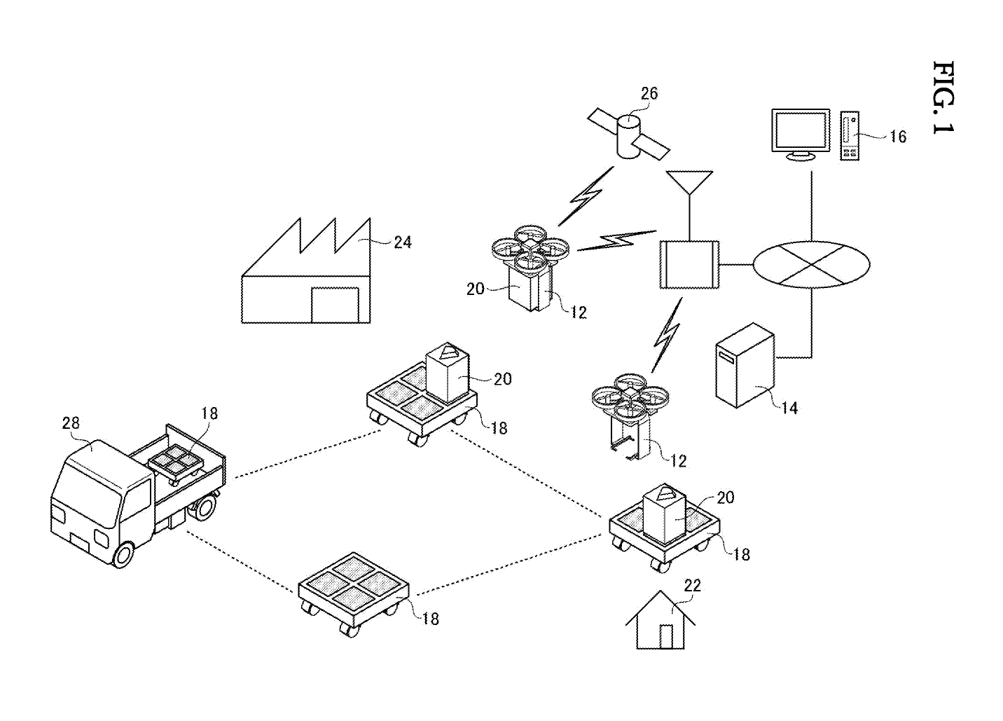

Referring to the drawings, an embodiment of a transport system using unmanned aerial vehicles according to the invention is described in detail. FIG. 1 is an illustration showing a whole system according to the embodiment of the transport system using unmanned aerial vehicles.

As shown in FIG. 1, the transport system using unmanned aerial vehicles of the embodiment has a structure for carrying packages using plural unmanned vehicles, namely, plural unmanned aerial vehicles 12 such as drones, flying space three-dimensionally by autopilot or remote control without boarding any human. Those unmanned aerial vehicles 12 can fly in attaching a container 20 for respectively containing package to be transported, and the container 20 is carried from a shipping source 24 such as a factory or a warehouse, via plural relay bases 18, to a delivery destination 22 such as an office or an individual's home. The container 20 and the unmanned aerial vehicle 12 are integrally controlled by the control apparatus made of a server 14 and an information terminal 16, such as a personal computer.

The server 14 forming the control apparatus, the plural relay bases 18, the plural containers 20, and the plural unmanned aerial vehicles 12 can transmit and receive information via wireless or wired network lines. Those apparatuses can be connected respectively using telecommunication protocols such as TCP/IP and utilizing the Internet and other networks. The unmanned aerial vehicles 12, the relay bases 18, and the containers 20 are formed with an IC chip for using the global positioning system, respectively, and can output as data the position measured by themselves utilizing the electromagnetic wave from GPS satellites 26.

The relay base 18 is placed on the ground in reflecting the flying distance of the unmanned aerial vehicles 12 so as to cover the range that this transport system of this embodiment makes delivery. For example, if the shipping source 24 is far away from the delivery destination 22 more than a standard flying distance of the unmanned aerial vehicle 12, package can be carried using the unmanned aerial vehicles 12 between the shipping source 24 and the delivery destination 22 by being relayed at the relay bases 18 where the relay bases 18 of at least a number that the quotient of the distance divided by the standard flying distance of the unmanned aerial vehicle 12 is deduced by one, are placed. It is preferable to arrange the plural relay bases 18 in a shape like a network to choose plural routes as not limiting to only one route from one place to another place. As described below, the relay base 18 has a structure movable by itself or fixed type. If the relay base 18 is of the fixed type, the relay bases 18 can be provided on the ground or water surface, and can be provided on a place on such as a rooftop or roof of buildings. If the relay base 18 is of the moving type, the relay base 18 may travel by itself, or the relay base 18 can be built at a part of a vehicle 28 such as, e.g., automobiles, trucks, ships, and trains. A special vehicle mounting the relay bases 18 may be arranged.

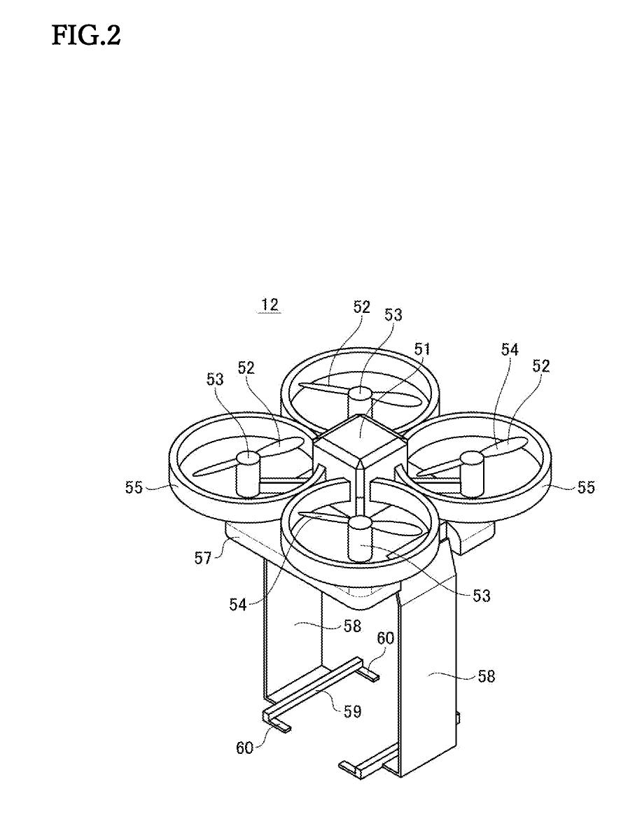

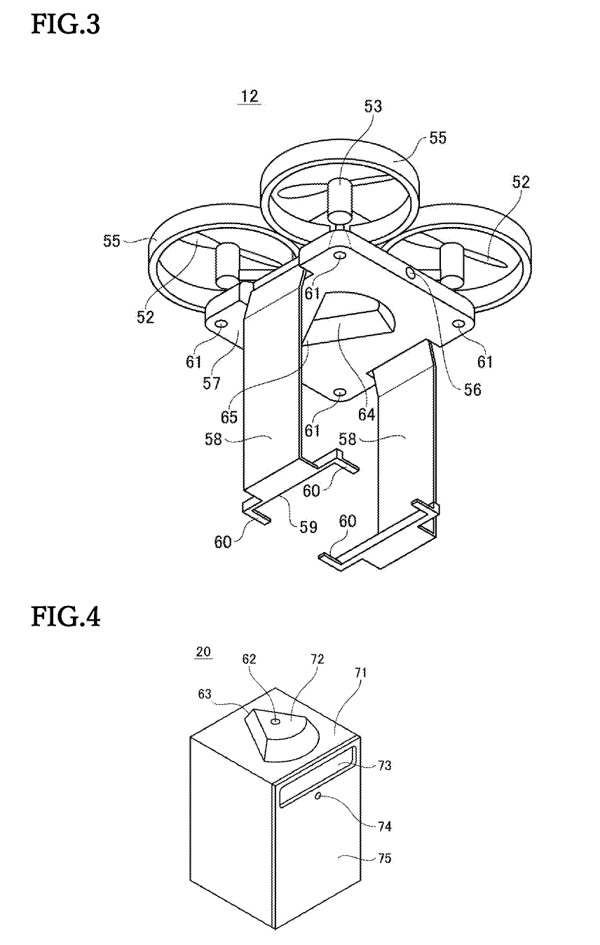

The unmanned aerial vehicle 12 used for the transport system according to the embodiment has a structure, as an example, as shown in FIGS. 2, 3. The unmanned aerial vehicle 12 has a structure formed with four rotors 52 at a periphery of a body section 51 mounting prescribed electronic devices so as to fly space three-dimensionally by autopilot or remote control. The rotor 52 has a structure that the rotary shaft of the motor rotating according to the supplied electric power becomes a shaft section 53, and is a rotating vane generating upward lift force according to the rotation. Vane sections 54 are formed in a fashion radially projecting in four directions from the shaft section 53 as a center, and a protection ring 55 is provided on an outer peripheral side of the vane sections 54 to protect the vane sections 54. The unmanned aerial vehicle 12 is capable of taking off, flying, and landing in maintaining the posture by controlling rotations of the four rotors 52, and can fly with relatively high speed and can hover, or stop, in the air at the same time.

The unmanned aerial vehicle 12 includes a body section 51 in a rectangular shape provided around the center thereof, and a platform section 57 provided below the body section 51 with circuitry and devices mounted for operating prescribed functions. Arms 58 are pivotably attached on sides of the platform section 57 to clamp the container 20, respectively. In a state not clamping the container 20, the pair of the arms 58 functions as legs supporting the unmanned aerial vehicle 12. The platform section 57 is formed in an approximately rectangular shape and has side faces obliquely extending as in a pedestal shape. The platform section 57 has cameras 56 on side portions thereof and cameras 61 on a bottom portion thereof. The unmanned aerial vehicle 12 includes, as devices disposed to the body section 51 and the platform section 57 arranged below the body section 51, a GPS (Global Positioning System) device for obtaining position information, a CPU controlling posture and flight state of the unmanned aerial vehicle 12, a battery generating electric power for rotating the motors driving the rotors and operating the circuitry and devices for providing prescribed functions, a wireless communication section for communicating the control apparatus when necessary, sensors and monitoring devices for monitoring the state of the retained container 20, an actuator for operating the pair of the arms 58 to be open and closed, and circumstance sensors for obtaining data on the circumstances of the surroundings during stop or flying and transmitting the data to the control apparatus.

With the transport system according to the embodiment, based on the position information obtained from the GPS device, the control apparatus made of the server 14 and the information terminal 16 makes a flight plan of the unmanned aerial vehicles 12, and functions to monitor operation of the system as to whether the operation follows the plan. In this transport system, the unmanned aerial vehicle 12 contributing to the conveyance of the packages is plural, and the efficiency of transportation can be improved where the flight plan is such that each vehicle makes a return trip at the relay base 18 as a center or hub. The packages can be in various sizes and weights, and therefore, it is necessary to choose the containers 20 capable of adaptively containing those packages. The flight plans of the unmanned aerial vehicles 12 including such choices of the containers 20 are produced with respect to ID (identification number) of the packages, and are stored in a memory region in the server 14, respectively.

The arms 58 formed at such an unmanned aerial vehicle 12 are members for clamping the container 20 from the lower side for taking off, flying, and landing together, and can clamp the container 20 while in the closed state and can release the container 20 while in the open state. The open and closed operation of the arms 58 is associated with the operation status of the unmanned aerial vehicles 12, and the unmanned aerial vehicle 12 approaches closely to a top face section 72 formed in an approximately fan or arc shape on a top face of the container 20 to be carried as the pair of the arms 58 is open in confirming the position of the container 20 on a setting table 42 on the relay base 18 with the four cameras 61 arranged below the platform section 57. At that time, where an angled portion 63 for providing orientation is arranged on the top face section 72 formed in a convex shape, the unmanned aerial vehicle 12 slides on a slope in a pedestal shape of the top face section 72 and comes into a united body through docking as the angled portion 63 of the top face section 72 fits in an angled portion 65 formed in a concave portion 64 at the bottom of the platform section 57. The unmanned aerial vehicle 12 confirms a signal from a sensor 62 detectable of a complete united body, and subsequently closes the pair of the arms 58. By closing the pair of the arms 58, the unmanned aerial vehicle 12 can clamp the container 20. At the flight destination, the unmanned aerial vehicle 12 makes landing in confirming the position of the setting table 42 in substantially the same way, and then, releases engagement between the container 20 and the unmanned aerial vehicle 12 by opening the pair of the closed arms 58. The shapes of the top face section 72 and the concave portion 64 fitting the top face section 72 are not limited to the approximately fan or arc shape, but can be any shape as far as the orientation is unambiguously given when fitted, and not matching angled portions but matching flat portions such as orientation flat may be possibly used.

The arms 58 clamping the container 20 in such a closed state further function as a supply route for supplying electric power from the battery section in the container 20 to the unmanned aerial vehicle 12. Accordingly, the flying distance as a whole becomes longer because the unmanned aerial vehicle can receive the supply of the electric power from the container 20 even where the flight distance of the unmanned aerial vehicle 12 is short. A rectangular bar shaped horizontal member 59 is formed at a lower end of the arm 58 as a position setting member, and the arm 58 clamps the container 20 completely upon fitting the horizontal member 59 into a fitting groove not shown at a bottom 76 of the container 20. An electrode portion 60 is further provided at the lower end of the arm 58, and where the electrode portion 60 contacts electrically an electrode portion not shown at the bottom of the container 20, the electric power from the battery section of the container 20 can be supplied to the unmanned aerial vehicle 12. In this embodiment, although the electric power supply is made through a circuit wiring through the arm 58 from the battery section of the container 20 to the unmanned aerial vehicle 12, the electric power supply can be done by wireless from the battery section of the container 20 to the unmanned aerial vehicle 12.

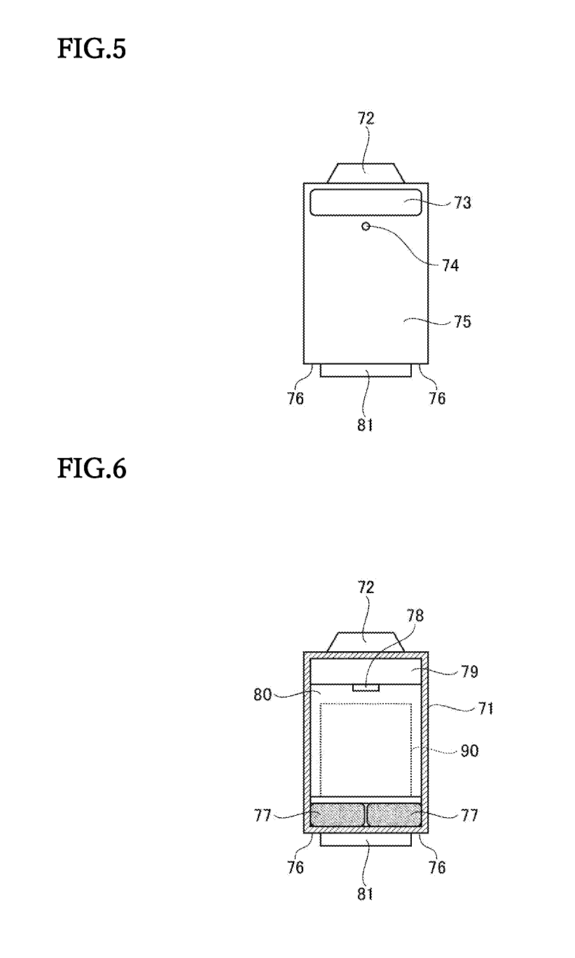

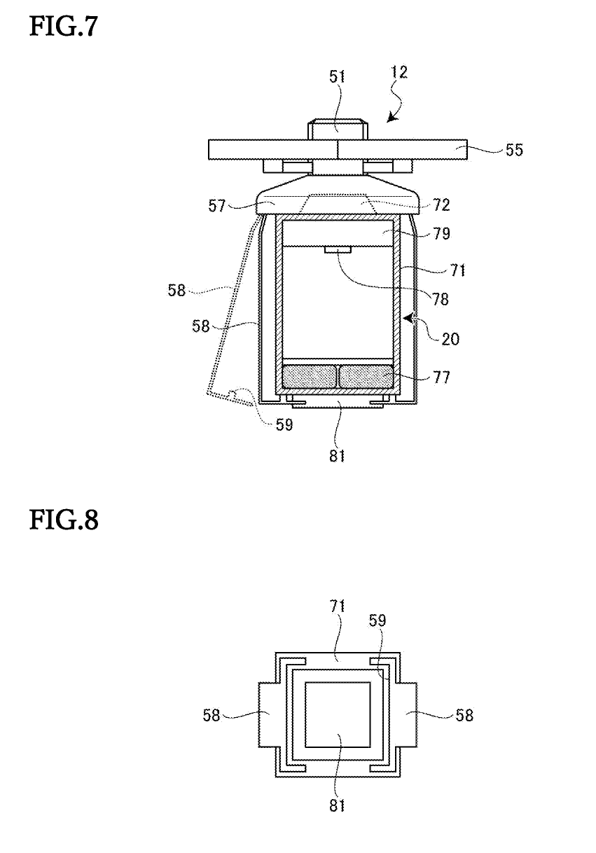

Referring to FIG. 4 through FIG. 8, a structure of the container 20 used in the transport system according to this embodiment is described. As shown in FIG. 4, the container 20 includes a body section 71 formed in a rectangular shape, and the top face section 72 is formed on the container 20 in the fan or arc shape fitting to the concave portion 64 of the platform section 57 of the unmanned aerial vehicle 12. A touch panel section 73 is formed on a top end of one side face serving as a door section 75 of the body section 71 to be used for a verification and input section formed on the container 20. The touch panel section 73 is a device displaying a variety of information on the container 20 and receiving entries made by operators and recipients of the packages, and the touch panel section 73 takes entries for such as keys and passwords for verification particularly during delivery periods. The container 20 has a mechanism that a lens 74 of the camera resides near the touch panel section 73, and the lens 74 of the camera can function for taking face recognition of the recipient during, e.g., the delivery period. While the container 20 is placed at the relay base 18 according to a remote control, the container 20 transmits a camera image showing a circumstantial state. The container 20 also has a CPU and memories mounted in a function section 79. A GPS device is also mounted at the top face section 72 or the function section 79 to obtain the current position information of the container. The CPU controls the touch panel section 73 and stores verification data from the control apparatus to the memories, thereby retrieving key entries, passwords, faces or finger prints, and other biological verification data from the built-in memories, verifying, e.g., the recipients upon comparisons. The verification data from the control apparatus employ data provided with ID of the container 20 itself in the header thereof, and are transmitted to the container 20 at a stage when the flight plan is set, and memorized in the built-in memories. Alternatively, the CPU of the container 20 transmits data for verification such as key entries, passwords, faces, finger prints, and other biological verification data to the control apparatus, compares the data with reference data for verification recorded at the control apparatus, and immediately transmits the verification consequences to the container 20 or the unmanned aerial vehicle 12. If the verification consequence is found as no good, the door section will not be open. The password or the like may be sent to the recipient from the control apparatus by, e.g., email.

The front side of the body section 71 of the container 20 functions as the door section 75 provided as a single door of a containing section 80 for containing packages. A battery section 77 made of plural batteries is arranged at a bottom of the containing section 80 of the container 20. The battery section 77 is detachably attached to the bottom of the containing section 80, and when charged rapidly, the battery section 77 can be charged upon disengaged from the bottom of the containing section 80. If a fully charged battery is attached upon replacement, the unmanned aerial vehicle 12 can fly in an early time without wasting time for charging the battery. Where charging is done while setting at a prescribed position at the relay base 18, and where the unmanned aerial vehicle 12 makes flight, the unmanned aerial vehicle 12 continues to fly in being supplied with the electric power in combination of the battery section of the container 20 and the battery built-in the unmanned aerial vehicle 12. In such a situation, the electric power is supplied from the double sources, and therefore the unmanned aerial vehicle 12 can continue flying in using remaining electric power even where one output is decreased or one is down, so that this system can hedge the risk of electrical power failure during flight.

A body pedestal section 81 is formed in an approximately rectangular shape on a bottom side of the body section 71 of the container 20, and the body pedestal section 81 engages a setting portion of the relay base 18 as described below. Because the body pedestal section 81 has a structure projecting downward, a gap is formed between the surface of the setting table and the bottom face of the body section 71 of the container 20 where the container 20 is set on the setting table of the relay base 18, and the unmanned aerial vehicle 12 can clamp the container 20 by inserting the tips of the arms 58 of the unmanned aerial vehicle 12 into the gap. The body pedestal section 81 sends electric power to the battery section 77 of this container 20 upon receiving the electric power from the relay base 18 when placed on the setting table of the relay base 18 described below, and serves to promote electronic charge at the battery section 77.

The container 20 by itself has a prescribed heat insulation function because a heat insulating material is used for the body section 71, and the container 20 is installed with a built-in weight sensor not shown for packages 90 and is capable of monitoring the current charge amount of the battery section 77. Those data are always transmitted as weight information of the packages and the current charge amount information to the control apparatus made of the server 14 and the information terminal 16 together with the position information of the container 20. A sensor 78 for monitoring the state of the packages is also provided at a ceiling of the containing section 80, and if any extraordinary situation occurs on the package during transportation, the sensor can inform the control apparatus of the extraordinary situation immediately. The container 20 further includes devices used for thermal management such as, e.g., heater and cooler devices. The container 20 therefore can be used for air transportation of the packages in performing the thermal management.

Those containers 20 in a plural number are used at the same time in this transport system of this embodiment, thereby improving efficiency of logistic services. In the example shown in the drawings, the container 20 is illustrated as one kind formed in the rectangular shape, but the shape of the container 20 is not limited to the rectangular shape but also other polygonal shapes or cylindrical shapes, or any other shapes, and the container can be one having a volume of two single containers horizontally arranged in tandem, or a small container having a height of a half length of the arm 58 or less than the half may be used. Where the containers 20 have various sizes thus described, the containers 20 can correspond efficiently to packages in variously mixed sizes. Alternatively, the containers 20 are not limited to those having various sizes, but the unmanned aerial vehicles 12 may be formed as those in mixed sizes or various conveyance capabilities. Matching between the various containers 20 and the various unmanned aerial vehicles 12 is automatically made by the control apparatus made of the server 14 and the information terminal 16, and such a choice is obtainable in use of a known program or programs. Where the size of the battery section 77 built in the container 20 is changed among the containers 20 in the same size, the charge capability of the container 20 is changeable. The unmanned aerial vehicle 12 may be designed to carry the plural containers 20 at one time.

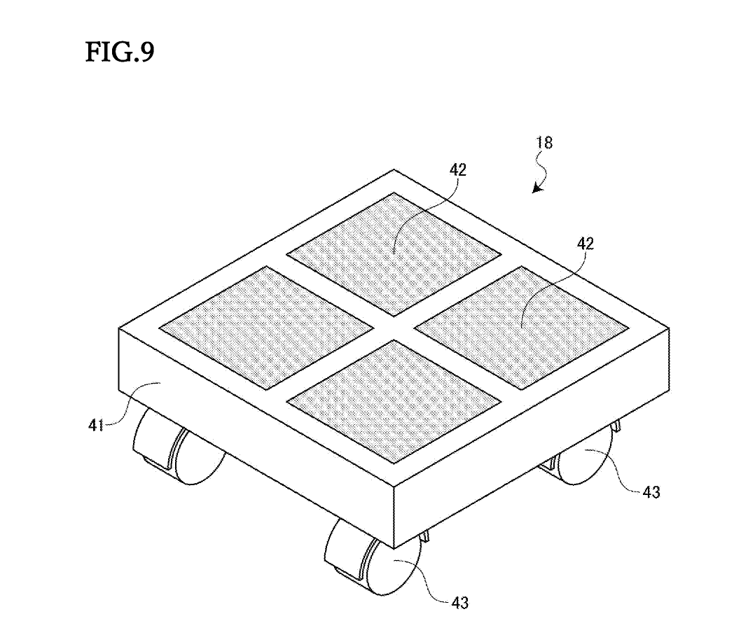

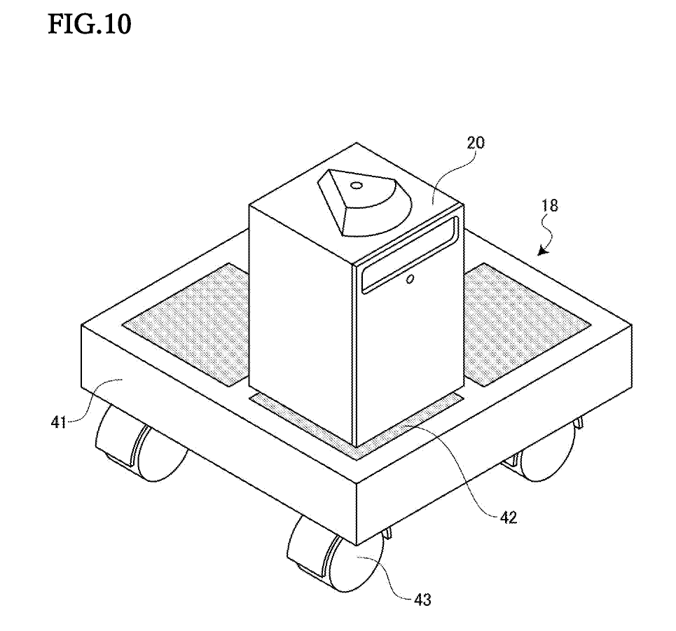

FIG. 9 and FIG. 10 show an example of the relay base 18. The relay base 18 can temporarily mount the single container 20 or plural containers 20 on the setting table 42 formed on the top thereof, can be used as a location to change the unmanned aerial vehicles 12, and can charge the containers 20 in a state that the containers 20 are set on the setting table 42. The relay base 18 by itself is connected with or incorporating other electric power supply sources such as, e.g., electric power line, electric power generator, solar battery, and wind power generator, and can send the electric power to the battery section 77 via the body pedestal section 81 of the container 20. Solar batteries may be arranged on the surface of the setting table 42. The relay base 18 has a structure plural or, in the illustrated example, four rectangular shaped sections of the setting table 42 on the top of the base body 41, and the battery is charged in a prescribed manner as the body pedestal section 81 of the container 20 couples the setting table 42. The relay base 18 is formed with wheels 43 at the bottom of the base body 41, and the wheels 43 are used where the relay base 18 is moved. The relay base 18 has a function transmitting the GPS information to the unmanned aerial vehicle 12 and the control apparatus, and when the unmanned aerial vehicle 12 approaches the relay base 18 closely, the unmanned aerial vehicle 12 can put the container 20 on the setting table 42 according to the transmissions of the signal with the relay base 18. As described above, the relay base 18 is movable or immovable. If the unmanned aerial vehicle 12 comes close to the relay base 18, the unmanned aerial vehicle 12 may move to a prescribed location by autopilot or remote control while confirming the image data capturing the positions of the relay base 18 and the setting table 42 with the camera mounted on the unmanned aerial vehicle 12.

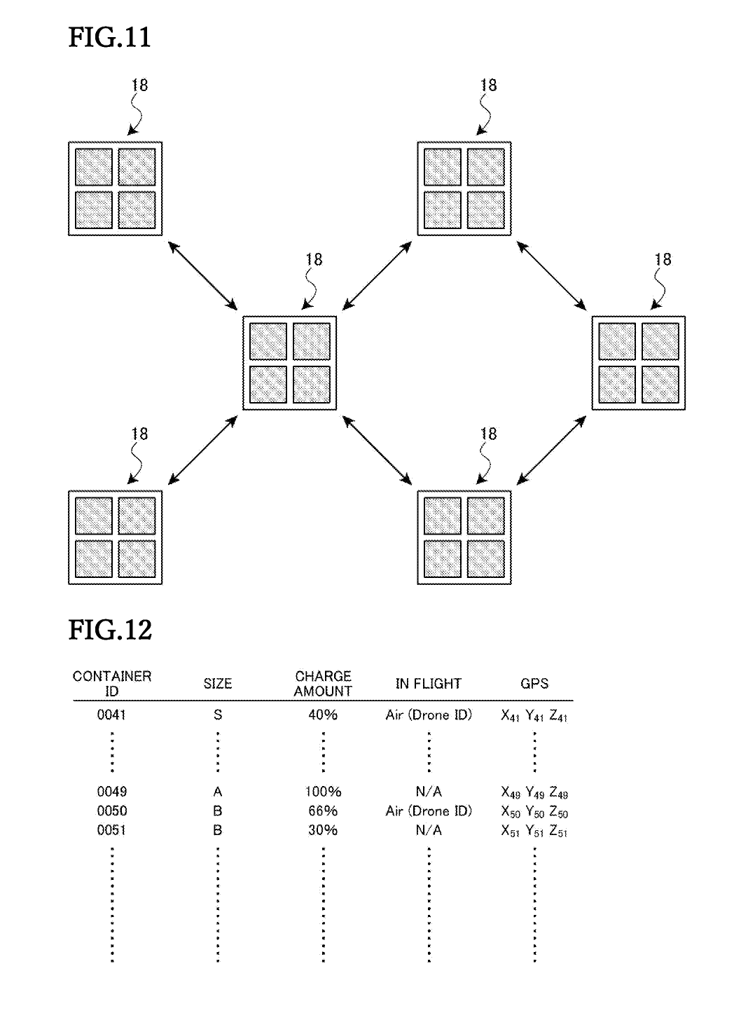

FIG. 11 shows an example of a layout of the relay bases 18. According to this layout example, the plural relay bases 18 are structured as to be arranged with certain intervals, and show a layout extending over a wide range. By setting the intervals of the plural relay bases 18 to be a certain distance, it would be enough to dispose plural standardized apparatuses as the unmanned aerial vehicles 12, so that the conveying method can be in a form that one unmanned aerial vehicle 12 travels reciprocally between the relay bases 18. In addition, where the power charge at the relay base 18 is done by a certain prescribed method, it is advantageous to render the setting of the conveyance plan easy.

FIG. 12 is a table showing information in a memory table managed by the control apparatus. With the control apparatus, the unmanned aerial vehicles 12 are assigned with individual IDs, respectively, where the position, the size, the charge status, and the like are managed. Concurrently, on the side of the containers 20, the containers 20 are assigned with individual IDs, respectively, and the size, the current charge amount information, the GPS position information are recorded and maintained in the table format and are renewed always with new information. In the memory table, it records whether or not the unmanned aerial vehicle 12 is in a carrying state, and this state can be outputted as tracking information from the control apparatus. The GPS position information of the relay bases 18 is stored in the server 14 of the control apparatus, and it is judged whether the container 20 of a certain ID is located at the relay bases 18 upon comparing the GPS position information of the relay bases 18 with the GPS position information of the container 20. Because the respective charge amounts of the containers 20 are sent as data to the control apparatus, if the charge amount is, e.g., 100%, the container 20 can be used for conveyance service as its flight is adequately prepared. If the charge amount is very low, the battery only of the unmanned aerial vehicle 12 becomes power source for flight, and such a plan is risky, so that it turns out that a flight plan expecting a high safe ratio cannot incorporate such a situation.

The respective unmanned aerial vehicles 12 transmit the current position information of the unmanned aerial vehicles 12 to the control apparatus in a form partly using the memory table, and the control apparatus can transmit the position information of the relay base 18 to the unmanned aerial vehicle 12 based on the received current position information of the respective unmanned aerial vehicles 12, and the control apparatus can use the information to correct the flight plan. The relay base 18 may be movable as sending the position information. The control apparatus can judge as to whether the system operates normally according to the position information of the containers 20 and the unmanned aerial vehicles 12 and image information from mounted cameras. For example, if the unmanned aerial vehicle is deviated from a produced flight plan, and if the container 20 is turned out to be moved from the relay base 18 due to theft, accident, or unnatural reason, the control apparatus may provide warning to notify the operators of the situation. In such a case, for example, the control apparatus may control to lock the operation of the unmanned aerial vehicle 12, and the touch panel section 73 may display an alarm to make the container 20 indicate extraordinary state and to generate warning sound.

According to the transport system of the embodiment, the unmanned aerial vehicle can receive the electric power supply from the battery section of the container for containing packages even during moving, and therefore, can fly over a wider range without restriction from capacity of the battery of the unmanned aerial vehicle, thereby improving usefulness in the delivery service in utilizing the transport system using the unmanned aerial vehicles according to the invention.

In the above embodiment, although the transport system using the unmanned aerial vehicles is described as having the structure of the battery section with the battery section 77 made of the plural batteries, the system may be structured with battery sections having other structures. The transport system may have a battery section having other structures, and for example, the battery section may be made of, e.g., fuel cell or other power generators utilizing such as hydrogen gas.

1-11. (canceled)

12. A transport system using unmanned aerial vehicles three-dimensionally movable upon receiving electric power supply, the transport system comprising the unmanned aerial vehicles flying from a shipping source to a delivery destination via a relay base and attaching a container thereto for containing a package to be transported, the container being formed with a battery section for charging electric power supplied to the unmanned aerial vehicles,
wherein the battery section formed at the container is charged at the relay base during a non-moving period.

13. The transport system using the unmanned aerial vehicles according to claim 12, wherein the unmanned aerial vehicle transmits current position information of the unmanned aerial vehicle to a control apparatus, and wherein the control apparatus transmits the position information of the relay base, based on the received current position information, to the unmanned aerial vehicle.

14. The transport system using the unmanned aerial vehicles according to claim 13, wherein the relay base is movable in transmitting the position information.

15. The transport system using the unmanned aerial vehicles according to claim 13, wherein the number of the containers containing the package to be transported is plural, wherein each container is managed using specific information, and wherein the control apparatus records charge amount information on current charge amounts of the respective containers according to the specific information.

16. The transport system using the unmanned aerial vehicles according to claim 15, wherein the container formed with the battery section has a charge amount sensor measuring the charge amount of the battery section of the container, and wherein the charge amount information from the charge amount sensor is sent to the control apparatus.

17. The transport system using the unmanned aerial vehicles according to claim 13, wherein the number of the containers containing the package to be transported is plural, wherein the position information on the current positions of the respective containers is transmitted to the control apparatus.

18. The transport system using the unmanned aerial vehicles according to claim 12, wherein the unmanned aerial vehicle has an arm openable for attaching the container and receives electric power supply from the battery section of the container via the arm.

19. The transport system using the unmanned aerial vehicles according to claim 13, wherein the container has a containing section for containing package to be transported, where the container has a door for loading and unloading the package to and from the containing section, and where the door of the containing section is controlled to be open and closed according to a certification consequence during a delivery period.

20. The transport system using the unmanned aerial vehicles according to claim 19, wherein the certification consequence is given from a comparison between entry data to a certification input section formed at the container and reference data held at a memory of the container or the control apparatus.

21. The transport system using the unmanned aerial vehicles according to claim 12, wherein the battery section formed at the container is detachably disposed to the container.

22. A container for unmanned aerial vehicles, comprising:
a container being attached to an unmanned aerial vehicle that is three-dimensionally movable, the container being transported from a shipping source to a delivery destination via a relay base, and containing a package,
wherein the container has a battery section for charging electric power supplied to the unmanned aerial vehicles, and wherein the battery section is charged at the relay base during a non-moving period.
